(19) United States
(12) Patent Application Publication
(10) Pub. No.: US 2011/0067733 A1
(43) Pub. Date: Mar. 24, 2011

(54) METHOD FOR CLEANING WITH FLUORINE COMPOUND

(75) Inventors: Hidekazu Okamoto, Tokyo (JP); Hideo Namatsu, Shinjuku-ku (JP)

(73) Assignee: ASAHI GLASS COMPANY, LIMITED, Tokyo (JP)

(21) Appl. No.: 12/951,241

(22) Filed: Nov. 22, 2010

Related U.S. Application Data
(63) Continuation of application No. PCT/JP2009/059388, filed on May 21, 2009.

(30) Foreign Application Priority Data
May 22, 2008 (JP) 2008-133944
May 22, 2008 (JP) 2008-133953

(51) Int. Cl. B08B 3/00

(52) U.S. Cl. 134/19

(57) ABSTRACT

To provide a cleaning method capable of favorably removing an object to be cleaned having a plasma polymer formed in a plasma etching step employing a fluorinated gas.

A cleaning method comprising an immersion step of immersing an object 1 to be cleaned in a cleaning liquid (fluorinated solvent) 3 containing at least a fluorine compound, wherein in the immersion step, the temperature t of the cleaning liquid 3 is at least the lower one of the normal boiling point of the fluorine compound contained in the cleaning liquid 3 at 1 atm and 100° C., and the atmospheric pressure is such a pressure that the fluorine compound is in a liquid state at the temperature t. Further, a cleaning method comprising an immersion step of immersing an object to be cleaned having a plasma polymer formed in a plasma etching step employing a fluorinated gas, in a cleaning liquid containing a fluorinated compound, wherein the fluorinated compound has a linear or branched perfluoroalkyl group having a number of carbon atoms of at least 5.

### TECHNICAL FIELD

The present invention relates to a cleaning method suitably employed in a process for producing various substrates such as microelectromechanical systems (MEMS) and large-scale integrated circuits (LSI).

### BACKGROUND ART

For production of LSI and MEMS, a fine pattern is required. Such a fine pattern is an etching pattern formed by etching using, as a mask, a resist pattern formed by means of exposure, development and rinsing, followed by cleaning. For the etching, plasma etching using a fluorinated gas is mainly employed. In order to improve the pattern dimensional accuracy in the plasma etching, it is required to carry out etching while a plasma-polymerized film is deposited on side walls of the pattern, whereby the side etching which occurs at the time of etching can be prevented. The side etching is diffusion of a reaction species (such as a fluorine radical) formed by the gas plasma in the lateral direction to increase the pattern dimensions.

For example, in silicon oxide film etching, hydrotrifluorocarbon CHF₃ added to the CF₄ gas plasma forms a CF₂ fragment thereby to form a plasma-polymerized film having a structure comprising (CF₂)ₙ. In silicon etching, plasmas of sulfur hexafluoride SF₆ and C₄F₈ to be a (CF₂)ₙ source are alternately formed to repeatedly carry out etching and deposition of the plasma-polymerized film thereby to prevent the side etching.

As described above, for the plasma etching, deposition of the plasma-polymerized film is inevitable, but after completion of the etching, it is required to remove the plasma-polymerized film. That is, when the etching is completed, as shown in FIG. 7(a) for example, a plasma-polymerized film 54 is deposited on side surfaces of a pattern 53, and it is inevitable to remove the film to achieve a state shown in FIG. 7(b). In the drawings, the numerical reference 51 represents a substrate and 52 a base film.

If the plasma-polymerized film remains, it will cause defects, stain or particles, thus leading to a decrease in the production yield, however, it is not easy to remove the plasma-polymerized film.

Further, strictly speaking, the plasma-polymerized film is not constituted only by the polymer of (CF₂)ₙ, and it includes an etching reaction product such as silicon and a component (e.g. a metal such as tungsten) of the base film of the etched film, and presence of such etching residue components makes it more difficult to remove the plasma-polymerized film.

Further, the plasma-polymerized film is attached also to the inner surface of an apparatus for carrying out the plasma etching. Heretofore, the plasma-polymerized film on the inner wall of the apparatus has been cleaned off by immersion in a cleaning liquid and scraping away by e.g. a brush.

As a cleaning method using a fluorinated solvent, heretofore, a method of cleaning off and removing grease using a chlorofluorocarbon (CFC) has been well known. In recent years, cleaning of a substrate is carried out by using a hydrofluoroether (HFE) or a hydrofluorocarbon (HFC) having a high fluorine content and low surface tension. As the cleaning process, for example, as shown in FIG. 8(a), a substrate 62 is immersed in a fluorinated solvent 61 at room temperature and at the same time, the fluorinated solvent 61 and the substrate 62 are shaken by an ultrasonic vibrator 63 comprising an ultrasonic oscillator.

Then, as shown in FIG. 8(b), the substrate 62 is immersed in a rinsing liquid 64 and rinsed. As the rinsing liquid, usually an alcohol such as 2-propanol is used. Finally, as shown in FIG. 8(c), the rinsing liquid is heated by a heater 65 to vaporize the rising liquid, and the resulting rinsing vapor 66 is applied to the substrate 62 to dry the substrate 62.

The following Patent Document 1 relates to a method of cleaning off a resist attached to a device substrate with a fluorinated solvent, and discloses a method of immersing a device substrate in a fluorinated solvent at room temperature or at 30° C., a method of bringing a device substrate into contact with a fluorinated solvent which is preliminarily converted to a supercritical state, and a method of immersing a device substrate in a fluorinated solvent at room temperature or at 30° C., and then converting the fluorinated solvent to a supercritical state.

### PRIOR ART DOCUMENTS

### Patent Documents

Patent Document 1: WO2007/114448

### DISCLOSURE OF THE INVENTION

### Object to be Accomplished by the Invention

However, by a conventional cleaning method using a fluorinated solvent, a high level cleaning effect to such an extent that the plasma-polymerized film can favorably be removed, cannot be obtained.

The present invention has been made to solve the above problem, and its object is to provide a cleaning method capable of favorably removing an object to be cleaned having a plasma polymer formed in a plasma etching step using a fluorinated gas.

### Means to Accomplish the Object

The present inventors have found that cleaning with a fluorine compound is effective to accomplish the above object and found that in the case of cleaning at room temperature, use of a fluorine compound having a linear or branched perfluoroalkyl group having a number of carbon atoms of at least 5 is effective. They have further found that in the case of cleaning at a specific temperature or higher, the fluorine compound is not limited to the above fluorine compound, and cleaning can be favorably conducted with a wider range of fluorine compounds. The present invention has been accomplished on the basis of this discovery.

That is, a first cleaning method of the present invention to accomplish the above object is a cleaning method comprising an immersion step of immersing an object to be cleaned in a cleaning liquid containing at least a fluorine compound, wherein in the immersion step, the temperature t of the cleaning liquid is at least the lower one of the normal boiling point of the fluorine compound contained in the cleaning liquid at 1 atm and 100° C., and the atmospheric pressure is such a pressure that the fluorine compound is in a liquid state at the temperature t (hereinafter referred to as a first embodiment of the present invention).

The immersion step is preferably carried out in a sealed container.

It is preferred that after the immersion step of immersing the object to be cleaned in the cleaning liquid in a liquid state, a step of converting the cleaning liquid to a supercritical fluid is carried out.

The fluorine compound preferably has a linear or branched perfluoroalkyl group having a number of carbon atoms of at least 4.

The cleaning method is suitable when the object to be cleaned contains at least a plasma polymer formed in a plasma etching step employing a fluorinated gas.

A second cleaning method of the present invention to accomplish the above object is a cleaning method comprising an immersion step of immersing an object to be cleaned containing a plasma polymer formed in a plasma etching step employing a fluorinated gas, in a cleaning liquid containing a fluorinated compound, wherein the fluorinated compound has a linear or branched perfluoroalkyl group having a number of carbon atoms of at least 5 (hereinafter referred to as a second embodiment of the present invention).

The fluorinated compound is preferably at least one member selected from the group consisting of hydrofluoroethers and hydrofluorocarbons.

The fluorinated compound is preferably a hydrofluoroether having a perfluoroalkyl group and an alkyl group bonded by means of an ether bond.

Further, the fluorinated compound is preferably a hydrofluorocarbon represented by Cₙ₊ₘF₂ₙ₊₁H₂ₘ₊₁ (wherein n is an integer of from 5 to 9, and m is an integer of from 0 to 2).

### Effects of the Invention

According to the cleaning method of the present invention, an object to be cleaned having a plasma polymer formed in a plasma etching step employing a fluorinated gas can be favorably removed, and the cleaning method of the present invention is suitably employed in a process for producing various substrates such as large-scale integrated circuits (LSI).

### BRIEF DESCRIPTION OF THE DRAWINGS

FIG. 1 is a drawing schematically illustrating an example of an apparatus suitable to carry out the cleaning method according to the first embodiment of the present invention.

FIG. 2 is a graph illustrating an example of a vapor-liquid equilibrium curve regarding a fluorine compound.

FIG. 3 is a graph illustrating the relation between the temperature conditions and the degree of removal of a plasma-polymerized film in the cleaning method according to the first embodiment of the present invention.

FIG. 4 is a graph illustrating the relation between the temperature conditions and the degree of removal of a plasma-polymerized film in the cleaning method according to the first embodiment of the present invention.

FIG. 5 is a drawing illustrating an effect of cleaning of a plasma-polymerized film by the cleaning method according to the first embodiment of the present invention.

FIG. 6 is a drawing illustrating an effect of cleaning of a plasma-polymerized film by the cleaning method according to the first embodiment of the present invention.

FIG. 7 is drawings illustrating a step of removing a plasma-polymerized film.

FIG. 8 is drawings illustrating a conventional method for cleaning a substrate.

FIG. 9 is a drawing illustrating an effect of cleaning of a plasma-polymerized film by the cleaning method according to the second embodiment of the present invention.

FIG. 10 is a drawing illustrating an effect of cleaning of a plasma-polymerized film by the cleaning method according to the second embodiment of the present invention.

### BEST MODE FOR CARRYING OUT THE INVENTION

### A. First Embodiment of the Present Invention

### <Cleaning Liquid Containing Fluorine Compound>

### [Fluorine Compound]

A fluorine compound to be used for the cleaning liquid containing a fluorine compound (hereinafter sometimes referred to as a fluorinated solvent) is preferably one having a perfluoroalkyl group.

The fluorine compound having a perfluoroalkyl group is preferably at least one member selected from the group consisting of perfluorocarbons, hydrofluoroethers and hydrofluorocarbons. It is more preferably at least one member selected from the group consisting of hydrofluoroethers and hydrofluorocarbons, in view of low global warming potential and light environmental burden.

The perfluoroalkyl group (hereinafter sometimes referred to as an Rf group) in the fluorine compound is a group (—CₙF₂ₙ₊₁ (wherein n is an integer)) having all hydrogen atoms bonded to carbon atoms of a linear or branched alkyl group (which may contain an etheric oxygen atom) represented by —CₙH₂ₙ₊₁ (wherein n is an integer), substituted by fluorine atoms.

The fluorine compound preferably has an Rf group having a number (n) of carbon atoms of at least 4, with a view to obtaining a good cleaning effect, more preferably contains an Rf group having a number of carbon atoms of at least 5.

In a case where a fluorine compound has two or more Rf groups in one molecule, at least one of them has a number (n) of carbon atoms of at least 4, more preferably at least 5. More preferably, all the Rf groups have a number (n) of carbon atoms of at least 4, preferably at least 5.

Further, the Rf group may contain an etheric oxygen atom. That is, the Rf group may be a group represented by CₚF₂ₚ₊₁—O—C_{q}F_{2q}— (wherein each of p and q which are independent of each other, is an integer of at least 1). In such a case, the number of carbon atoms of the Rf group is the total (p+q) of p and q.

With respect to the above p and q, at least one of them is preferably at least 4, and it is particularly preferred that p is at least 4.

The number of carbon atoms of the Rf group is preferably at most 10 in view of drying properties after cleaning, and in view of the melting point and the viscosity in terms of handling as a liquid, and is more preferably at most 9, furthermore preferably at most 8.

The fluorine compounds may be used alone or as a mixture of two or more.

The hydrofluoroether may, for example, be specifically methyl perfluorobutyl ether (C₄F₉OCH₃), ethyl perfluorobutyl ether (C₄F₉OCH₂CH₃), methyl perfluoropentyl ether (C₅F₁₁OCH₃), ethyl perfluoropentyl ether (C₅F₁₁OCH₂CH₃), methyl perfluorohexyl ether (C₆F₁₃OCH₃), ethyl perfluorohexyl ether (C₆F₁₃OCH₂CH₃), methyl perfluoroheptyl ether (C₇F₁₅OCH₃), ethyl perfluoroheptyl ether (C₇F₁₅OCH₂CH₃), methyl perfluorooctyl ether (C₈F₁₇OCH₃), ethyl perfluorooctyl ether (C₈F₁₇OCH₂CH₃), methyl perfluorooctyl ether (C₉F₁₉OCH₃), ethyl perfluorononyl ether (C₉F₁₉OCH₂CH₃), methyl perfluorodecyl ether (C₁₀F₂₁OCH₃), ethyl perfluorodecyl ether (C₁₀F₂₁OCH₂CH₃), 1,1,1,2-tetrafluoroethyl-1,1,1-trifluoroethyl ether (C₂F₄HOCH₂CF₃), 1,1,2,2,3,3-hexafluoro-1-(1,2,2,2-tetrafluoroethoxy)propyl-perfluoropropyl ether (C₃F₇OC₃F₆OCFHCF₃), 1,1,1,2,3,4,4,5,5,5-decafluoro-2-(trifluoromethyl)-3-(methoxy)pentane (CF₃CF(CF₃)CF(OCH₃)CF₂CF₃), 1,1,1,2,3,4,4,5,5,5-decafluoro-2-(trifluoromethyl)-3-(ethoxy)pentane (CF₃CF(CF₃)CF(OC₂H₅)CF₂CF₃), 1,1,2,2-tetrafluoro-1-(2,2,2-trifluoroethoxy)ethane (CF₂(OCH₂CF₃)CF₂H), 1,1,2,3,3,3-hexafluoro-1-(2,2,2-trifluoroethoxy)propane (CF₂(OCH₂CF₃)CFHCF₃), 1,1,2,2-tetrafluoro-1-(2,2,3,3-tetrafluoropropoxy)ethane (CF₂(OCH₂CF₂CF₂H)CF₂H) or 1,1,2,3,3,3-hexafluoro-1-(2,2,3,3-tetrafluoropropoxy)propane (CF₂(OCH₂CF₂CF₂H)CFHCF₃).

Among such hydrofluoroethers, preferred is one having a perfluoroalkyl group and an alkyl group bonded by means of an ether bond.

Particularly, from the viewpoint of easiness to use as a cleaning liquid (e.g. drying properties after cleaning, handlability as a low viscous liquid at room temperature), preferred is methyl perfluoropentyl ether (C₅F₁₁OCH₃), ethyl perfluoropentyl ether (C₅F₁₁OCH₂CH₃), methyl perfluorohexyl ether (C₆F₁₃OCH₃), ethyl perfluorohexyl ether (C₆F₁₃OCH₂CH₃), methyl perfluoroheptyl ether (C₇F₁₅OCH₃), ethyl perfluoroheptyl ether (C₇F₁₅OCH₂CH₃), methyl perfluorooctyl ether (C₈F₁₇OCH₃) or ethyl perfluorooctyl ether (C₈F₁₇OCH₂CH₃).

The hydrofluorocarbon may, for example, be specifically 1,1,1,3,3-pentafluorobutane (CF₃CH₂CF₂CH₃), 1,1,1,2,2,3,4,5,5,5-decafluoropentane (CF₃CF₂CFHCFHCF₃), 1H-monodecafluoropentane (C₅F₁₁H), 3H-monodecafluoropentane (C₅F₁₁H), 1H-tridecafluorohexane (C₆F₁₃H), 1H-pentadecafluoroheptane (C₇F₁₅H), 3H-pentadecafluoroheptane (C₇F₁₅H), 1H-heptadecafluorootane (C₈F₁₇H), 1H-nonadecafluorononane (C₉F₁₉H), 1H-perfluorodecane (C₁₀F₂₁H), 1,1,1,2,2,3,3,4,4-nonafluorohexane (C₄F₉CH₂CH₃), 1,1,1,2,2,3,3,4,4,5,5,6,6-tridecafluorooctane (C₆F₁₃CH₂CH₃) or 1,1,1,2,2,3,3,4,4,5,5,6,6,7,7,8,8-heptadecafluorodecane (C₈F₁₇CH₂CH₃).

Among such hydrofluorocarbons, preferred is one represented by Cₙ₊ₘF₂ₙ₊₁H₂ₘ₊₁ (wherein n is an integer of from 4 to 9, and m is an integer of from 0 to 2).

Particularly, from the viewpoint of easiness to use as a cleaning liquid (e.g. drying properties after cleaning, handlability as a low viscous liquid at room temperature), preferred is 1H-monodecafluoropentane (C₅F₁₁H), 3H-monodecafluoropentane (C₅F₁₁H), 1H-tridecafluorohexane (C₆F₁₃H), 1H-pentadecafluoroheptane (C₇F₁₅H), 3H-pentadecafluoroheptane (C₇F₁₅H), 1H-heptadecafluorooctane (C₈F₁₇H) or 1,1,1,2,2,3,3,4,4,5,5,6,6-tridecafluorooctane (C₆F₁₃CH₂CH₃).

The perfluorocarbon may, for example, be a compound having all hydrogen atoms of a linear or branched hydrocarbon substituted by fluorine atoms (perfluorinated hydrocarbon); a compound having all hydrogen atoms of an alkyl group of a linear or branched alkylamine substituted by fluorine atoms (perfluorinated alkylamine); or a compound having all hydrogen atoms in a linear or branched alkyl ether substituted by fluorine atoms (perfluorinated alkyl ether).

The preferred number of carbon atoms in the hydrocarbon, the alkyl group of an alkylamine and the alkyl ether is the same as the preferred number of carbon atoms of the above Rf group.

In the cleaning liquid, the content of the fluorine compound is preferably higher than 50 mass %, more preferably higher than 80 mass %.

### [Other Fluorine Compound]

As the fluorine compound used for the cleaning liquid, the fluorine compound having a perfluoroalkyl group is used and in addition, other fluorine compound not included in the above fluorine compound may be used in combination.

Such other fluorine compound may, for example, be a hydrochlorofluorocarbon (such as dichloropentafluoropropane or dichlorofluoroethane); a fluorinated ketone; a fluorinated ester; a fluorinated unsaturated compound; or a fluorinated aromatic compound. Among them, a hydrochlorofluorocarbon is preferred as other fluorine compound.

They may be used alone or as a mixture of two or more in combination.

As other fluorine compound, a fluorine compound which is in a liquid state under the temperature and pressure conditions in the immersion step is preferably selected.

In the cleaning liquid (fluorinated solvent), the content of such other fluorine compound is preferably at most 50 mass %, more preferably at most 20 mass %.

[Compound which Generates Decomposed Product]

Further, a compound which will be decomposed by heating to generate a decomposed product, under the temperature and pressure conditions in the immerse step, may be contained in the cleaning liquid. For example, some fluorine compounds are decomposed when heated at high temperature to generate hydrogen fluoride. Specifically, C₄F₉OCH₂CH₃ is heat-decomposed at 200° C. or higher to generate hydrogen fluoride. When such a compound is contained in the cleaning liquid, it will be possible to etch a silicon oxide film in the immersion step and as a result, particles on the surface of the silicon oxide film can be removed by lift-off. When such a compound which generates a decomposed product is contained in the cleaning liquid, the addition amount is preferably within a range of from 10 to 50 mass %, more preferably from 15 to 25 mass % in 100 mass % of the cleaning liquid (fluorinated solvent).

### [Fluorinated Alcohol]

The cleaning liquid (fluorinated solvent) according to the first embodiment of the present invention may contain a fluorinated alcohol. The fluorinated alcohol means a compound having a fluorine atom and a hydroxy group. The fluorinated alcohol is preferably selected from known compounds which are in a liquid state under the temperature and pressure conditions in the immersion step. Further, the fluorinated alcohol more preferably constitutes an azeotropic mixture with the fluorine compound contained in the cleaning liquid.

The fluorinated alcohol may, for example, be specifically 2,2,2-trifluoroethanol, 2,2,3,3-tetrafluoropropanol, 2,2,3,3,3-pentafluoropropanol, 2,2,3,4,4,4-hexafluorobutanol, 2,2,2-trifluoro-1-(trifluoromethyl)ethanol, 2,2,3,3,4,4,5,5-octafluoropentanol or 1,1,1,3,3,3-hexafluoroisopropanol. Among them, 2,2,3,3,4,4,5,5-octafluoropentanol is preferred as the fluorinated alcohol.

In the cleaning liquid (fluorinated solvent), the content of the fluorinated alcohol is such that the total content with an organic solvent having no fluorine atom described hereinafter is preferably at a level of from 5 to 20 mass %, more preferably from 5 to 10 mass %.

[Organic Solvent having No Fluorine Atom]

The cleaning liquid (fluorinated solvent) in the first embodiment of the present invention may further contain an organic solvent having no fluorine atom. The organic solvent is preferably selected from known organic solvents which are in a liquid state under the temperature and pressure conditions in the immersion step. Further, the organic solvent having no fluorine atom more preferably constitutes an azeotropic mixture with the fluorine compound contained in the cleaning liquid.

The organic solvent having no fluorine atom may, for example, be specifically an alcohol such as ethanol or 2-propanol; an acetate such as propylene glycol monomethyl ether acetate; or an amine such as dimethylethanolamine, allylamine or aminobenzylamine. Among them, an amine is preferred as the organic solvent having no fluorine atom.

Such an organic solvent can be used also as a pH adjustor, and by addition of such an organic solvent, the zeta potential required to prevent re-adhesion of particles can be adjusted.

In the cleaning liquid (fluorinated solvent), the content of the organic solvent having no fluorine atom is such that the total content with the above-mentioned fluorinated alcohol is preferably at a level of from 5 to 20 mass %, more preferably from 5 to 10 mass %.

### [Other Component]

The cleaning liquid (fluorinated solvent) according to the first embodiment of the present invention may contain, in addition to the above-described components, as the case requires, other component having no fluorine atom.

For example, a nonionic surfactant such as sorbitan fatty acid ester, polyoxyethylene alkylamine fatty acid amide or alkylmonoglyceryl ether; an ampholytic surfactant such as alkyl dimethylamine oxide; an anionic surfactant such as monoalkyl sulfate; or a cationic surfactant such as alkyltrimethylammonium salt may be added alone or as a mixture of two or more. Particularly, a nonionic surfactant is preferred as the surfactant.

In a case where a surfactant is added, the addition amount is preferably from 0.01 to 5 mass %, more preferably from 0.05 to 1 mass % in the cleaning liquid (fluorinated solvent).

The method for preparing the cleaning liquid (fluorinated solvent) is not particularly limited, and the cleaning liquid can be obtained by uniformly mixing the above fluorine compound and components to be added as the case requires.

### <Object to be Cleaned>

In the cleaning method according to the first embodiment of the present invention, the object to be cleaned which is to be cleaned is not particularly limited, and an object to which a conventional method of using a fluorinated solvent is applicable can be cleaned by the cleaning method according to the first embodiment of the present invention, and a higher cleaning effect than the conventional method can be obtained.

Particularly a plasma polymer is hardly well cleaned off by the conventional cleaning method employing a fluorinated solvent, but can be favorably removed by the cleaning method according to the first embodiment of the present invention.

In the first embodiment of the present invention, the plasma polymer is a deposit formed in a step of plasma etching employing a fluorinated gas, and is formed in many cases when the fluorinated gas contains a compound (such as C₄F₈ or CHF₃) capable of forming a CF₂ fragment to be a (CF₂)ₙ source. Further, e.g. a CH₂ fragment formed by decomposition of the resist pattern during the plasma etching relates to formation of a plasma polymer in some cases. The plasma polymer includes one containing an etching residue component. In this specification, a plasma polymer deposited in the form of a film will be referred to as a plasma-polymerized film.

For example, the present invention is preferably applied to removal of a plasma-polymerized film deposited on a substrate or a plasma-polymerized film attached to an inner wall of an apparatus to carry out plasma etching, in a process for producing various substrates such as microelectromechanical systems (MEMS) and large-scale integrated circuits (LSI).

Further, in addition to the plasma-polymerized film, the present invention is preferably applied to remove, as an object to be cleaned, grease attached to a member such as an electronic component of e.g. IC, a precision machinery component or a glass substrate, or a stain such as a flux of e.g. a printed board.

### <Cleaning Method>

One embodiment of the cleaning method according to the first embodiment of the present invention will be described with reference to drawings. Here, it is described with reference to a plasma-polymerized film on a substrate as an object to be cleaned as an example.

### [Immersion Step]

First, as shown in FIG. 1, a substrate 1 is immersed in a fluorinated solvent (cleaning liquid) 3 (immersion step). In this step, the temperature t of the fluorinated solvent 3 is controlled to be at least the lower one of the normal boiling point of the fluorine compound contained in the fluorinated solvent 3 and 100° C., and the atmospheric pressure is controlled to be a pressure such that the fluorine compound contained in the fluorinated solvent 3 at the temperature t is in a liquid state. The normal boiling point is the boiling point at 1 atm.
(1) In a case where the normal boiling point of the fluorine compound contained in the fluorinated solvent 3 is 100° C. or higher, the temperature t of the fluorinated solvent 3 is set to 100° C. or higher. The atmospheric pressure is such that the fluorine compound is in a liquid state. The liquid state includes a boiling state. In a case where the temperature t is at least 100° C. and at most the normal boiling point, the immersion step may be carried out either in an open system or in a closed system. The immersion step is carried out preferably in a closed system. In a case where the temperature t is higher than the normal boiling point, the immersion step is carried out in a closed system.
(2) In a case where the normal boiling point of the fluorine compound contained in the fluorinated solvent 3 is less than 100° C., the temperature t of the fluorinated solvent 3 is at least the normal boiling point. In order that the atmospheric pressure is a pressure such that the fluorine compound is in a liquid state, the immersion step is carried out preferably in a closed system.

In a case where the fluorinated solvent 3 contains at least two fluorine compounds, the temperature t of the fluorinated solvent 3 is at least the normal boiling point (the azeotropic point in the case of an azeotropic mixture, the same applies hereinafter) of at least one fluorine compound among the respective normal boiling points of the at least two fluorine compounds contained in the fluorinated solvent 3. It is preferably at least the highest normal boiling point.

The atmospheric pressure may be a pressure such that at least one fluorine compound among the at least two fluorine compounds contained in the fluorinated solvent 3 is in a liquid state at the temperature t. It is preferably such a pressure that all the compounds are in a liquid state.

The upper limit of the temperature t of the fluorinated solvent 3 in the immersion step is not particularly limited, and a sufficient cleaning effect can be obtained at a temperature of at most 200° C. A too high temperature t more than necessary is disadvantageous in view of the cost.

Further, as disclosed in after-mentioned Test Example for removal of plasma-polymerized film, depending on the type of the fluorine compound, there is an optimum temperature range within which a favorable cleaning effect can be obtained. Accordingly, the temperature t of the fluorinated solvent 3 in the immersion step is preferably set within an optimum temperature range within which a favorable cleaning effect can be obtained, depending on the type of the fluorine compound and the type of the object to be cleaned, within a range of at least the normal boiling point of the fluorine compound contained in the fluorinated solvent and at most 200° C.

The optimum temperature range can be obtained by measuring the relation between the temperature t of the fluorinated solvent 3 in the immersion step and the amount of a remaining object to be cleaned after the immersion step.

The immersion step is carried out preferably in a closed container 2.

Specifically, a substrate (object to be cleaned) 1 is put in a closed container 2, a fluorinated solvent 3 is introduced, and the system is brought into a closed state. Otherwise, after the system is brought into a closed state, the fluorinated solvent 3 may be introduced from the outside (the introduction means is not shown).

In the immersion step, the substrate 1 is immersed so that at least a surface to be cleaned (a surface to which an object to be cleaned is attached) of the substrate 1 is in contact with the fluorinated solvent 3.

The closed container 2 is not particularly limited so long as it has a pressure-resistant structure capable of maintaining an airtight interior. As described above, the container used in the first embodiment of the present invention is preferably a closed container having a pressure-resistant structure.

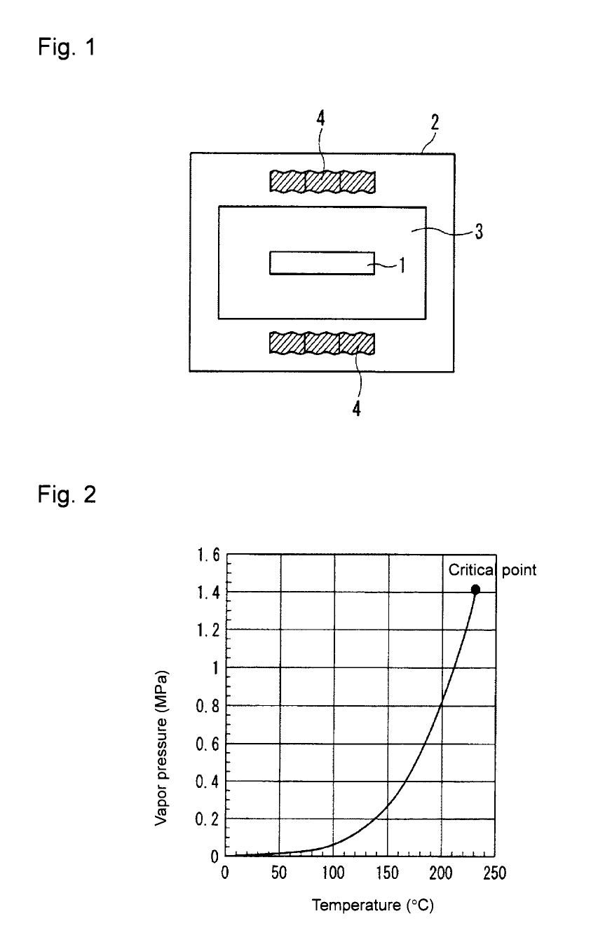

For example, a container with a brief lid to be heated, has no pressure-resistant structure, and accordingly the cleaning liquid when reaches the boiling point is vaporized, and thus a liquid state at high temperature of at least the boiling point cannot be achieved. Further, with a container having a water cooling pipe on its lid, vaporization can be prevented by water cooling, but a liquid at a temperature of at least the boiling point cannot be obtained. That is, in order that the cleaning liquid is liquefied at a temperature of at least the boiling point, a pressure resistant container capable of maintaining high pressure to a certain extent is required. The pressure-resistant level is such that the cleaning liquid can be liquefied at a predetermined temperature. For example, as shown in the vapor-liquid equilibrium curve in FIG. 2, in the case of C₆F₁₃CH₂CH₃ (after-mentioned Test Example 7), the pressure (vapor pressure) under which vapor-liquid equilibrium is achieved at 170° C. is 0.45 MPa (gauge pressure, the same applies hereinafter). Thus, a pressure resistance to a level of maintaining 0.5 MPa is sufficient.

Then, by a heater 4 provided in the closed container 2, the temperature of the fluorinated solvent 3 is raised to a predetermined temperature and in addition, the pressure is adjusted as the case requires so that the pressure in the closed container is under a predetermined atmospheric pressure. The pressure in the closed container voluntarily increases along with heating by the heater 4. The pressure can be adjusted, for example, by e.g. a back pressure valve or various valves.

In a case where the capacity of the closed container 2 is sufficiently large relative to the amount of the fluorinated solvent 3, the temperature of the fluorinated solvent 3 and the temperature in the closed container 2 reach equilibrium in short time, and thus the fluorinated solvent 3 can be heated to a predetermined temperature also by a method of heating the closed container 2 to a predetermined temperature by the heater 4 before introduction of the fluorinated solvent 3 and then introducing the fluorinated solvent 3.

The heater 4 is not particularly limited so long as it can raise the temperature of the fluorinated solvent 3 to a predetermined temperature. A sheath heater, a cartridge heater, a film heater, a dielectric heating type heater, etc. may be used. Further, the heater 4 may be embedded in the wall of the closed container 2 or may be plunged to the fluorinated solvent 3 without any problem.

In the immersion step, if the time (immersion time) for which the substrate is immersed in the fluorinated solvent 3 under the predetermined atmospheric pressure at the predetermined temperature t is too short, the cleaning effect will be insufficient, and if it is too long, the efficiency will be decreased. Accordingly, it is set within such a range that no such drawbacks occur. For example, the immersion time is preferably at a level of from 1 minute to 120 minutes, more preferably from 10 minutes to 60 minutes.

Further, as the case requires, the fluorinated solvent may be changed at least once in the immersion step. In a case where the fluorinated solvent is changed, the type of the fluorinated solvent, the temperature (t) of the fluorinated solvent and/or the atmospheric pressure may be changed.

The immersion step may be carried out by the batch, or may be carried out continuously such that the fluorinated solvent is made to flow at an optional flow rate.

### [Supercritical Step]

After the immersion step of immersing the substrate in the fluorinated solvent 3 in a liquid state for a predetermined immersion time, a step of converting the fluorinated solvent in which the substrate is immersed to a supercritical fluid (a supercritical step) may be carried out by bringing the temperature of the fluorinated solvent to the critical temperature or higher and bringing the atmospheric pressure to the critical pressure or higher.

As the diffusion rate is increased by bringing a supercritical state, the fluorinated solvent in the form of a supercritical fluid is infiltrated to the microfine region, and cleaning of minute portions is possible, whereby the cleaning effect can be more improved. Further, when the substrate is dried in a supercritical fluid state, no unnecessary stress will be applied since no surface tension is applied in the supercritical state, whereby the substrate can be dried without destroying a structure such as a pattern formed on the substrate.

In the supercritical step, if the time (contact time) in which the fluorinated solvent in a supercritical state is brought into contact with the substrate is too short, the cleaning effect will not sufficiently be improved, and if it is too long, the efficiency will be decreased. Accordingly, it is set within such a range that no such drawbacks occur. For example, the contact time is preferably at a level of from 1 minute to 120 minutes, more preferably from 10 minutes to 60 minutes.

In Table 1 are shown results of examples of measuring critical points (critical temperature and critical pressure) of fluorinated solvents comprising various fluorine compounds by a method of measuring the intensity of the transmitted light. Specifically, each solvent is put in a high pressure cell with a window, the temperature and the pressure are increased, and the temperature and the pressure when the intensity of the transmitted light changes are regarded as the critical temperature and the critical pressure, respectively.

In the supercritical step, a supercritical state can be easily brought since the pressure voluntarily increases to the vicinity of the critical pressure when the temperature is raised to the critical temperature (about 200° C.) in a closed state.

TABLE 1

| | | Critical | Critical |
|---|---|---|---|
| Test | | temperature | pressure |
| Example | Fluorine compound | (° C.) | (MPa) |
| 1 | C₂F₄HOCH₂CF₃ | 189 | 2.34 |
| 2 | C₃F₇OC₃F₆OCFHCF₃ | 202 | 1.15 |
| 3 | C₄F₉OCH₃ | 185 | 1.95 |
| 4 | C₄F₉OCH₂CH₃ | 198 | 1.82 |
| 5 | C₄F₉CH₂CH₃ | 195 | 1.86 |
| 6 | C₆F₁₃OCH₃ | 211 | 1.39 |
| 7 | C₆F₁₃CH₂CH₃ | 233 | 1.41 |
| 8 | C₅F₁₁H | 165 | 1.82 |
| 9 | C₆F₁₃H | 188 | 1.57 |
| 10 | C₈F₁₇H | 230 | 1.23 |

After the predetermined immersion time is completed, or in a case where the supercritical step is carried out, after the predetermined contact time is completed, the heated fluorinated solvent 3 is discharged (the discharge system is not shown) from the sealed container 2, the sealed container 2 is opened to the atmospheric pressure, and finally the substrate 1 is taken out. Since the fluorinated solvent is in a state where it is heated to the normal boiling point or higher or in a supercritical state, the fluorinated solvent attached to the substrate surface is instantaneously dried so that the substrate 1 is in a dry state. Accordingly, no specific drying means is required.

In such a manner, a substrate cleaned with a fluorinated solvent is obtained.

### [Rinsing Step]

After the immersion step and the supercritical step as the case requires are carried out, before the sealed container 2 is opened for drying, the fluorinated solvent 3 may be replaced with a rinsing liquid to carry out a rinsing step of immersing the substrate in the rinsing liquid.

The rinsing liquid may be a low boiling point organic solvent having a normal boiling point of at most 100° C. For example, an alcohol, a ketone or an ether may be used as the rinsing liquid. The rinsing liquid may be a low boiling point fluorine compound so that the substrate is more easily dried.

The temperature and the atmospheric pressure of the rinsing liquid in the rinsing step are such a temperature and a pressure that the rinsing liquid is in a liquid state in the sealed container 2. As the case requires, after the immersion step and the supercritical step as the case requires are carried out, the heater 4 is turned off to decrease the temperature in the sealed container 2 and the temperature of the substrate 1 to less than the normal boiling point of the rinsing liquid. The pressure in the sealed container is decreased along with the decrease of the temperature.

If the immersion time (rinsing time) in the rinsing liquid is too short, the rinsing effect will be insufficient, and if it is too long, the efficiency will be decreased. Accordingly, it is set within a range that no such drawbacks occur. For example, the rinsing time is preferably from 1 minute to 120 minutes, more preferably from 10 minutes to 60 minutes. The rinsing liquid may be changed at least once during the rinsing step as the case requires.

After the predetermined rinsing time is completed, the rinsing liquid is discharged (discharge system is not shown) from the sealed container, and the sealed container is opened. Then, the rinsing liquid attached to the substrate 1 is heated to the boiling point or higher to vaporize the rinsing liquid, thereby to dry the substrate 1.

In such a manner, a substrate cleaned with a fluorinated solvent and further rinsed with a rinsing liquid is obtained.

### B. Second Embodiment of the Present Invention

### <Cleaning Liquid Containing Fluorinated Compound>

### [Fluorinated Compound]

A fluorinated compound used for the cleaning liquid (hereinafter sometimes referred to as a fluorinated solvent) containing a fluorinated compound has a perfluoroalkyl group.

The perfluoroalkyl group (hereinafter sometimes referred to as a Rf group) in the fluorinated compound is a group (CₙF₂ₙ₊₁ (wherein n is an integer)) having all hydrogen atoms bonded to carbon atoms of a linear or branched alkyl group represented by CₙH₂ₙ₊₁ (wherein n is an integer), substituted by fluorine atoms.

In the second embodiment of the present invention, the number (n) of carbon atoms of the Rf group is at least 5, more preferably at least 6. When the number (n) of carbon atoms of the Rf group is at least 5, a high effect of removing a plasma polymer is obtained.

In a case where the fluorinated compound has at least two Rf groups in one molecule, at least one has a number (n) of carbon atoms of at least 5, preferably at least 6. More preferably, all Rf groups have a number (n) of carbon atoms of at least 5, preferably at least 6.

Further, an Rf group having a carbon-carbon bond chain having a number (n) of carbon atoms of at least 6, may contain an etheric oxygen atom. That is, the Rf group may be a group represented by CₚF₂ₚ₊₁—O—C_{q}F_{2q}— (wherein each of p and q which are independent of each other, is an integer of at least 1, and at least one of p and q is at least 5). In such a case, the number of carbon atoms of the Rf group is the total (p+q) of p and q, and is at least 6. Among the above p and q, it is preferred that at least p is at least 5.

The number of carbon atoms of the Rf group is preferably at most 10 in view of drying properties after cleaning, and in view of the melting point, the viscosity, etc. in terms of handling as a liquid, and is more preferably at most 9, furthermore preferably at most 8.

The fluorinated compound having a perfluoroalkyl group is preferably at least one member selected from the group consisting of perfluorocarbons, hydrofluoroethers and hydrofluorocarbons. Among them, preferred is at least one member selected from the group consisting of hydrofluoroethers and hydrofluorocarbons, in view of low global warming potential and light environmental burden.

The fluorinated compounds may be used alone or as a mixture of two or more.

The hydrofluoroether is preferably one having a perfluoroalkyl group and an alkyl group bonded by means of an ether bond.

The hydrofluoroether having an Rf group having a carbon number of at least 5 may, for example, be specifically methyl perfluoropentyl ether (C₅F₁₁OCH₃), ethyl perfluoropentyl ether (C₅F₁₁OCH₂CH₃), methyl perfluorohexyl ether (C₆F₁₃OCH₃), ethyl perfluorohexyl ether (C₆F₁₃OCH₂CH₃), methyl perfluoroheptyl ether (C₇F₁₅OCH₃), ethyl perfluoroheptyl ether (C₇F₁₅OCH₂CH₃), methyl perfluorooctyl ether (C₈F₁₇OCH₃), ethyl perfluorooctyl ether (C₈F₁₇OCH₂CH₃), methyl perfluorononyl ether (C₉F₁₉OCH₃), ethyl perfluorononyl ether (C₉F₁₉OCH₂CH₃), methyl perfluorodecyl ether (C₁₀F₂₁OCH₃) or ethyl perfluorodecyl ether (C₁₀F₂₁OCH₂CH₃).

Among them, in view of easiness of use as a cleaning liquid (e.g. drying properties after cleaning, handlability as a low viscous liquid at room temperature), preferred is methyl perfluoropentyl ether (C₅F₁₁OCH₃), ethyl perfluoropentyl ether (C₁₅F₁₁OCH₂CH₃), methyl perfluorohexyl ether (C₆F₁₃OCH₃), ethyl perfluorohexyl ether (C₆F₁₃OCH₂CH₃), methyl perfluoroheptyl ether (C₇F₁₅OCH₃), ethyl perfluoroheptyl ether (C₇F₁₅OCH₂CH₃), methyl perfluorooctyl ether (C₈F₁₇OCH₃) or ethyl perfluorooctyl ether (C₈F₁₇OCH₂CH₃).

The hydrofluorocarbon is preferably one represented by Cₙ₊ₘF₂ₙ₊₁H₂ₘ₊₁ (wherein n is an integer of from 5 to 9, and m is an integer of from 0 to 2).

The hydrofluorocarbon having an Rf group having a number of carbon atoms of at least 5 may, for example, be specifically 1H-monodecafluoropentane (C₅F₁₁H), 3H-monodecafluoropentane (C₅F₁₁H), 1H-tridecafluoroehexane (C₆F₁₃H), 1H-pentadecafluoroheptane (C₇F₁₅H), 3H-pentadecafluoroheptane (C₇F₁₅H), 1H-heptadecafluorooctane (C₈F₁₇H), 1H-nonadecafluorononane (C₉F₁₉H), 1H-perfluorodecane (C₁₀F₂₁H), 1,1,1,2,2,3,3,4,4,5,5,6,6-tridecafluorooctane (C₆F₁₃CH₂CH₃) or 1,1,1,2,2,3,3,4,4,5,5,6,6,7,7,8,8-heptadecafluorodecane (C₈F₁₇CH₂CH₃).

Particularly, from the viewpoint of easiness to use as a cleaning liquid (e.g. drying properties after cleaning, handlability as a low viscous liquid at room temperature), preferred is 1H-monodecafluoropentane (C₅F₁₁H), 3H-monodecafluoropentane (C₅F₁₁H), 1H-tridecafluorohexane (C₆F₁₃H), 1H-pentadecafluoroheptane (C₇F₁₅H), 3H-pentadecafluoroheptane (C₇F₁₅H), 1H-heptadecafluorooctane (C₈F₁₇H) or 1,1,1,2,2,3,3,4,4,5,5,6,6-tridecafluorooctane (C₆F₁₃CH₂CH₃).

The perfluorocarbon may, for example, be a compound having all hydrogen atoms of a linear or branched hydrocarbon substituted by fluorine atoms (perfluorinated hydrocarbon); a compound having all hydrogen atoms of an alkyl group of a linear or branched alkylamine substituted by fluorine atoms (perfluorinated alkylamine); or a compound having all hydrogen atoms in a linear or branched alkyl ether substituted by fluorine atoms (perfluorinated alkyl ether).

The preferred number of carbon atoms in the hydrocarbon, the alkyl group of an alkylamine and the alkyl ether is the same as the preferred number of carbon atoms of the above Rf group.

In the cleaning liquid, the content of the fluorinated compound is preferably higher than 50 mass %, more preferably higher than 80 mass %.

### [Other Fluorinated Compound]

In the second embodiment of the present invention, as the fluorinated compound used for the cleaning liquid, the above-described fluorinated compound having a linear or branched perfluoroalkyl group having a number of carbon atoms of at least 5 is used and in addition, other fluorinated compound not included in the above fluorinated compound may be used in combination.

Such other fluorinated compound may be the same as “Other fluorinated compound” exemplified in the first embodiment of the present invention.

Such other fluorinated compounds may be used alone or as a mixture of two or more.

Such other fluorinated compound is preferably selected from ones which are a liquid or a supercritical fluid under the temperature and pressure conditions in the immersion step.

The content of such other fluorinated compound in the cleaning liquid (fluorinated solvent) is preferably at most 50 mass %, more preferably at most 20 mass %.

### [Fluorinated Alcohol]

The cleaning liquid (fluorinated solvent) according to the second embodiment of the present invention may contain a fluorinated alcohol. The fluorinated alcohol means a compound having a fluorine atom and a hydroxy group. The fluorinated alcohol is preferably selected from known compounds which are a liquid or a supercritical fluid under the temperature and pressure conditions in the immersion step. Further, the fluorinated alcohol more preferably constitutes an azeotropic mixture with the fluorinated compound contained in the cleaning liquid.

Specific examples of the fluorinated alcohol are the same as “Fluorinated alcohol” exemplified in the first embodiment of the present invention.

In the cleaning liquid (fluorinated solvent), the content of the fluorinated alcohol is such that the total content with an organic solvent described hereinafter is preferably at a level of from 5 to 20 mass %, more preferably from 5 to 10 mass %.

[Organic Solvent having No Fluorine Atom]

The cleaning liquid (fluorinated solvent) in the second embodiment of the present invention may further contain an organic solvent having no fluorine atom. The organic solvent is preferably selected from known organic solvents which are in a liquid state under the temperature and pressure conditions in the immersion step. Further, the organic solvent having no fluorine atom more preferably constitutes an azeotropic mixture with the fluorinated compound contained in the cleaning liquid.

Specific examples of the organic solvent are the same as “Organic solvent having no fluorine atom” exemplified in the first embodiment of the present invention.

Such an organic solvent can be used also as a pH adjustor, and by addition of such an organic solvent, the zeta potential required to prevent re-adhesion of particles can be adjusted.

In the cleaning liquid (fluorinated solvent), the content of the organic solvent having no fluorine atom is such that the total content with the above-mentioned fluorinated alcohol is preferably at a level of from 5 to 20 mass %, more preferably from 5 to 10 mass %.

### [Other Components]

The cleaning liquid (fluorinated solvent) in the second embodiment of the present invention may contain other component having no fluorine atom as the case requires in addition to the above fluorinated compound, other fluorinated compound, fluorinated alcohol and organic solvent.

The specific examples are the same as “Other component” (various surfactants) exemplified in the first embodiment of the present invention, and such other components may be added alone or as a mixture of two or more.

In a case where a surfactant is added, the addition amount is preferably from 0.01 to 5 mass %, more preferably from 0.05 to 1 mass % in the cleaning liquid (fluorinated solvent).

A method for preparing the cleaning liquid (fluorinated solvent) is not particularly limited, and the cleaning liquid can be obtained by uniformly mixing the above fluorinated compound and components added as the case requires.

### <Object to be Cleaned>

In the cleaning method according to the second embodiment of the present invention, an object to be cleaned contains a plasma polymer.

In the second embodiment of the present invention, the plasma polymer is a deposit formed in a plasma etching step employing a fluorinated gas, and is formed in many case when the fluorinated gas contains a compound (such as C₄F₈ or CHF₃) capable of forming a CF₂ fragment to be a (CF₂)ₙ source.

Further, e.g. a CH₂ fragment formed by decomposition of the resist pattern during plasma etching relates to formation of a plasma-polymerized film in some cases. The plasma polymer includes one containing an etching residue component.

A plasma polymer is hardly favorably cleaned off by a conventional cleaning method employing a fluorinated solvent, but can be favorably removed by the cleaning method according to the second embodiment of the present invention.

For example, the cleaning method is preferably applied to removal of a plasma-polymerized film deposited on a substrate or a plasma-polymerized film attached to the inner wall of an apparatus for carrying out plasma etching in a process for producing various substrates such as microelectromechanical systems (MEMS) and large-scale integrated circuits (LSI).

### <Cleaning Method>

The cleaning method according to the second embodiment of the present invention will be described. The cleaning method will be described with reference to a plasma-polymerized film on a substrate as an object to be cleaned as an example.

### [Immersion Step]

A substrate is immersed in a fluorinated solvent (cleaning liquid) in an open system or closed system container (immersion step). The immersion is carried out preferably under either of the following conditions (a) and (b).
(a) The temperature of the fluorinated solvent is increased to a temperature of at least 80° C., typically 100° C. The fluorinated solvent is in a liquid state or in a supercritical state. Particularly, the fluorinated solvent is preferably in a liquid state. In a case where the temperature of the fluorinated solvent is at least the boiling point of the fluorinated compound contained therein, the immersion step is carried out preferably under pressure in a closed system. In a case where the temperature of the fluorinated solvent is less than the boiling point of the fluorinated compound contained therein, the immersion step may be carried out in an open system, but is preferably carried out in a closed system or in an apparatus provided with a reflux portion.

The temperature of the fluorinated solvent in the immersion step is not particularly limited, but a sufficient cleaning effect is obtained at a temperature of at most 200° C., preferably at most 150° C. A temperature higher than necessary is disadvantageous in view of the cost.
(b) The temperature of the fluorinated solvent is at least room temperature (25° C.) and less than 80° C., preferably from 30 to 60° C., and ultrasonic waves are applied to shake the fluorinated solvent and the substrate.

Particularly, the conditions (a) are more preferred with a view to favorably removing a plasma polymer.

A method of carrying out the immersion step under the conditions (a) or (b), can be carried out by properly employing a known method as a method of cleaning an object to be cleaned other than a plasma-polymerized film with a fluorinated solvent.

In the immersion step, if the time (immersion time) for which the substrate is immersed in the fluorinated solvent is too short, the cleaning effect will be insufficient, and if it is too long, the cleaning efficiency will be decreased. Accordingly, it is set within such a range that no such drawbacks occur. For example, the immersion time is preferably from 1 to 120 minutes, more preferably from 10 to 60 minutes.

Further, as the case requires, the fluorinated solvent may be changed at least once in the immersion step. In a case where the fluorinated solvent is changed, the type of the fluorinated solvent, the temperature (t) of the fluorinated solvent and/or the atmospheric pressure may be changed.

The immersion step may be carried out by the batch, or may be carried out continuously such that the fluorinated solvent is made to flow at an optional flow rate.

### [Supercritical Step]

In the cleaning method according to the second embodiment of the present invention, after the substrate is immersed in the fluorinated solvent in a liquid state for a predetermined immersion time in the immersion step, a step of converting the fluorinated solvent in which the substrate is immersed to a supercritical fluid (a supercritical step) may be carried out by bringing the temperature of the fluorinated solvent to the critical temperature or higher and bringing the atmospheric pressure to the critical pressure or higher.

As the diffusion rate is increased by bringing a supercritical state, the fluorinated solvent in the form of a supercritical fluid is infiltrated to the microfine region, and cleaning of minute portions is possible, whereby the cleaning effect can be more improved. Further, when the substrate is dried in a supercritical fluid state, no unnecessary stress will be applied since no surface tension is applied in the supercritical state, whereby the substrate can be dried without destroying a structure such as a pattern formed on the substrate.

In the supercritical step, if the time (contact time) in which the fluorinated solvent in a supercritical state is brought into contact with the substrate is too short, the cleaning effect will not sufficiently be improved, and if it is too long, the efficiency will be decreased. Accordingly, it is set within such a range that no such drawbacks occur. For example, the contact time is preferably from 1 to 120 minutes, more preferably from 10 to 60 minutes.

After the predetermined immersion time is completed, or in a case where the supercritical step is carried out, after the predetermined contact time is completed, the heated fluorinated solvent is discharged from the container. Further, in a case where the cleaning method according to the second embodiment of the present invention is carried out in a closed system, the closed container is opened to an atmospheric pressure. Then, finally the substrate is taken out from the container. Then, the substrate is dried as the case requires.

Particularly in a case where the fluorinated solvent is in a state where it is heated to the normal boiling point or higher in the closed container or in a supercritical state, the fluorinated solvent attached to the substrate surface is instantaneously dried by opening the closed container, and the substrate is in a dry state. Accordingly, no specific drying means is required.

In such a manner, a substrate cleaned with a fluorinated solvent is obtained.

### EXAMPLES

### A. Examples for the First Embodiment of the Present Invention

### <Test Example for Removal of Plasma-Polymerized Film>

In Table 2 are shown cleaning effects when a plasma-polymerized film was cleaned by using fluorinated solvents comprising various fluorine compounds. The fluorinated solvent (cleaning liquid) comprises 100 mass % of a fluorine compound shown in Table 2. As an object to be cleaned, a plasma-polymerized film (solid film not patterned) having a thickness of from 800 to 900 nm deposited on a silicon substrate using C₄F₈ gas plasma was used.

Details under “Cleaning conditions” shown in Table 2 are shown below.

### [Cleaning Conditions]

(1) 30° C.: A substrate was immersed in a fluorinated solvent having its temperature adjusted to 30° C. under atmospheric pressure for 60 minutes, and then dried by heating in an oven at 120° C. for 1 hour.
(2) Boiling: A substrate was immersed in a fluorinated solvent in a boiling state by being heated to the normal boiling point or higher under atmospheric pressure for 1 hour, and then taken out.
(3) 100° C., 130° C., 150° C., 200° C.: A fluorinated solvent was introduced to a closed space and heated to each of predetermined temperatures (t=100° C., 130° C., 150° C. or 200° C.) and at the same time, the pressure was elevated to such an atmospheric pressure that the fluorinated solvent was in a liquid state. A substrate was immersed in the fluorinated solvent in this state for 1 hour and then taken out.

For example, in a case where a fluorinated solvent comprising a fluorine compound having a normal boiling point of at most 80° C. was used and cleaning was carried out at a temperature t=150° C., the atmospheric pressure was adjusted to from 0.5 to 0.8 MPa (gauge pressure). In a case where a fluorinated solvent having a normal boiling point of from 98 to 121° C. was used and t=100° C. or 130° C., the fluorinated solvent is in a liquid state under a pressure of 0.1 MPa, and accordingly the atmospheric pressure was adjusted to 0.1 MPa. That is, the pressure was a pressure above (higher) than the vapor-liquid equilibrium curve of the fluorinated solvent at a temperature t.

### [Evaluation]

The substrate cleaned under each conditions was visually observed and evaluated based on evaluation standards ×: plasma-polymerized film remained over the entire surface, Δ: part of plasma-polymerized film removed but not completely removed, and ◯: plasma-polymerized film completely removed. In Table 2, “-” represents unevaluated.

TABLE 2

| | Fluorine compound used as fluorinated solvent | | | | | | | | |
|---|---|---|---|---|---|---|---|---|---|
| | | Number of carbon | Normal boiling | Cleaning conditions | | | | | |
| Test Ex. | Fluorine compound | atoms of Rf group | point (° C.) | 30° C. | Boling | 100° C. | 130° C. | 150° C. | 200° C. |
| 1 | C₂F₄HOCH₂CF₃ | 1, 1 | 56 | X | X | X | X | X | X |
| 2 | C₃F₇OC₃F₆OCFHCF₃ | 3 + 3, 1 | 106 | X | X | X | X | Δ | X |
| 3 | C₄F₉OCH₃ | 4 | 61 | X | X | X | X | ◯ | X |
| 4 | C₄F₉OCH₂CH₃ | 4 | 76 | X | X | Δ | Δ | ◯ | Δ |
| 5 | C₄F₉CH₂CH₃ | 4 | 68 | X | X | Δ | Δ | ◯ | Δ |
| 6 | C₆F₁₃OCH₃ | 6 | 98 | X | ◯ | ◯ | ◯ | ◯ | — |
| 7 | C₆F₁₃CH₂CH₃ | 6 | 115 | X | ◯ | ◯ | ◯ | ◯ | ◯ |
| 8 | C₅F₁₁H | 5 | 48 | X | Δ | ◯ | — | Δ | — |
| 9 | C₆F₁₃H | 6 | 71 | X | X | ◯ | ◯ | ◯ | ◯ |
| 10 | C₈F₁₇H | 8 | 121 | X | ◯ | ◯ | ◯ | — | ◯ |

As evident from the results in Table 2, at 30° C., since the dissolution rate of the plasma-polymerized film is remarkably low, the plasma-polymerized film could not be removed.

In a case where the fluorinated solvent was boiling or heated to from 100 to 200° C. in a closed system, the solubility of the plasma-polymerized film was improved as compared with a case of 30° C., and complete removal was possible.

Particularly when the atmospheric pressure was such that the fluorinated solvent was in a liquid state at a temperature higher than the boiling point, the plasma-polymerized film was completely removed in many cases. In a case where the boiling point was at least 100° C., a removal effect appeared in some cases with a cleaning liquid heated to 100° C. in a closed system.

Further, when a fluorinated solvent has an Rf group (CₙF₂ₙ₊₁) having a number of carbon atoms of at least 4 (n≧4), complete removal of the plasma-polymerized film was possible. This is considered to be because the plasma-polymerized film has a structure comprising (CF₂)ₙ, and the plasma-polymerized film is likely to swell when the carbon chain of the Rf group (CₙF₂ₙ₊₁) in the fluorinated solvent is longer (n is larger), and as a result, it is likely to be dissolved. Further, when the number of carbon atoms of the Rf group is at least 6 (n≧6), an optimum temperature range within which the plasma-polymerized film could be completely removed is wider, such being more favorable.

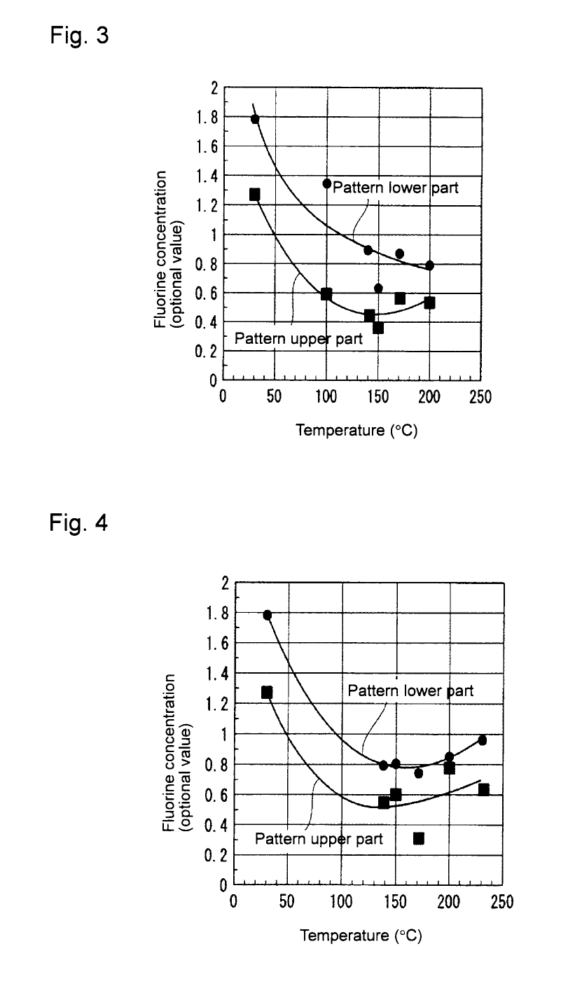

FIGS. 3 and 4 are graphs illustrating results of examining the degree of cleaning, when side surfaces of a silicon pattern (width: 100 μm, depth: 30 μm) etched by alternate treatment with SF₆ gas plasma and C₄F₈ gas plasma were cleaned employing C₆F₁₃H (Test Example 9) or C₆F₁₃CH₂CH₃ (Test Example 7), changing the temperature conditions.

The SF₆ gas plasma contributes to etching, and the C₄F₈ gas plasma contributes to protection of pattern side walls (formation of plasma-polymerized film) to prevent side etching.

The degree of cleaning was evaluated by a method of detecting the remaining fluorine concentration at the upper part and the lower part of the pattern side surfaces by Auger spectroscopy.

The cleaning conditions were such that the temperature of the fluorinated solvent was raised to the respective temperatures shown in the horizontal axis, and the atmospheric pressure was adjusted so that the fluorinated solvent was in a liquid state. A silicon pattern was immersed in the fluorinated solvent in such a state for 10 minutes and then taken out.

FIG. 3 is a graph illustrating results of cleaning with C₆F₁₃H (Test Example 9), and FIG. 4 is a graph illustrating results of cleaning with C₆F₁₃CH₂CH₃ (Test Example 7). The fluorine concentration in a state before cleaning was substantially the same as that after the treatment at 30° C.

In both graphs, the remaining fluorine concentration is minimum at a temperature of from 150 to 170° C., and accordingly it is found that this temperature is optimum for the removal by dissolution.

In Table 2, the evaluation result at 100° C. in Test Example 9 is ◯, whereas in FIG. 3, the fluorine concentration at the pattern lower part when the fluorinated solvent is 100° C. is high. This means that the plasma-polymerized film on the pattern side surfaces is hardly removed than the solid film of the plasma-polymerized film.

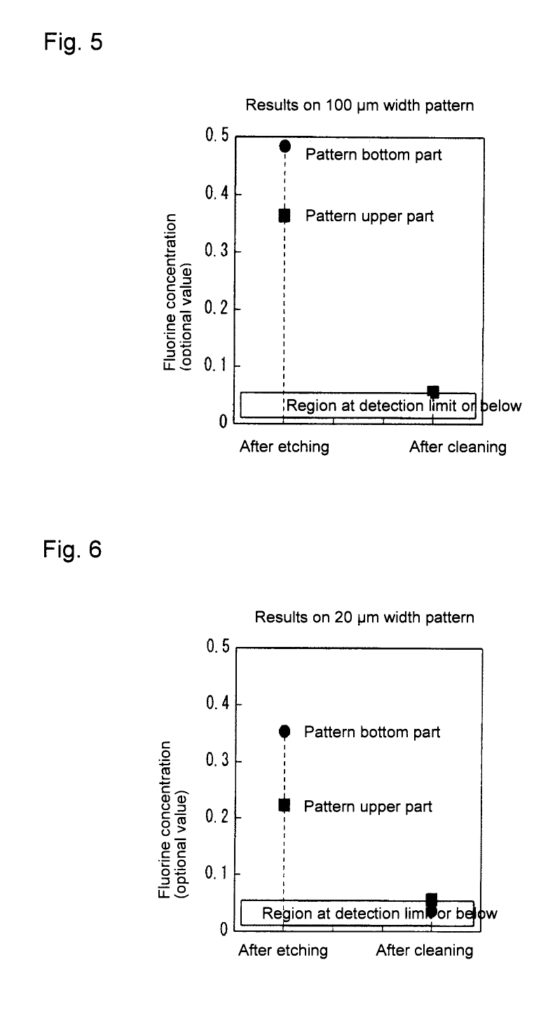

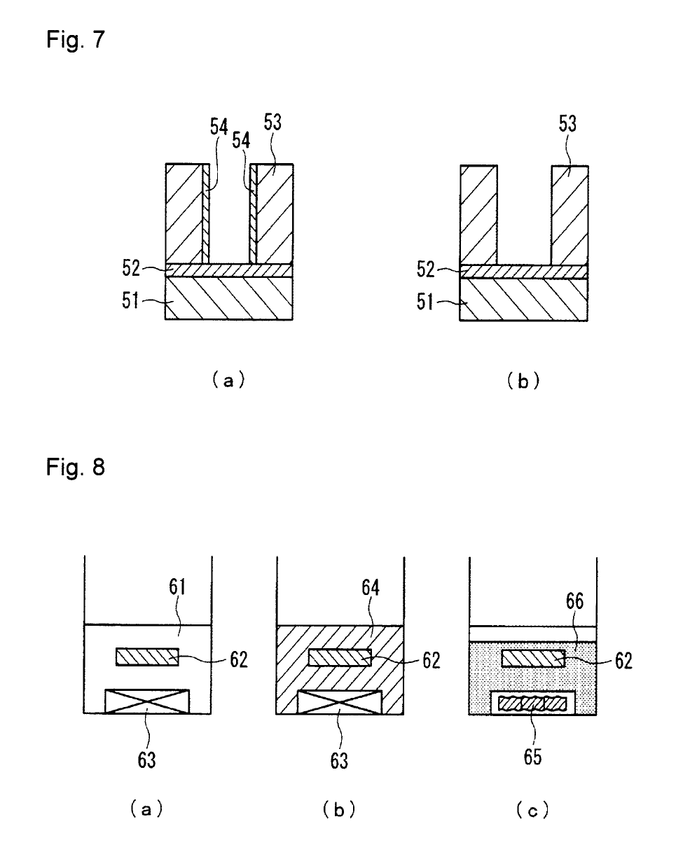

FIGS. 5 and 6 are graphs illustrating the results of Auger spectroscopy examining the degree of cleaning when side surfaces of a silicon pattern (width: 100 μm in FIG. 5 and width: 20 μm in FIG. 6, and depth: 40 μm in both Figs.) etched by alternate treatment with SF₆ gas plasma and C₄F₈ gas plasma, were cleaned with C₆F₁₃CH₂CH₃ (Test Example 7).

The cleaning was carried out by immersing a pattern in C₆F₁₃CH₂CH₃ (Test Example 7) heated to 170° C. under such an atmospheric pressure that the fluorinated solvent was in a liquid state for 30 minutes and then taking the pattern out.

As evident from the results shown in FIGS. 5 and 6, the fluorine concentration is decreased to the detection limit or below after cleaning, that is, the plasma-polymerized film is completely removed, independently of the pattern width and the pattern depth.

As described above, according to the cleaning method according to the first embodiment of the present invention, an object to be cleaned having a plasma-polymerized film formed in a plasma etching step employing a fluorinated gas can be favorably cleaned to remove the plasma-polymerized film.

Accordingly, a plasma-polymerized film attached to an inner wall cover of an etching apparatus used for a plasma etching step employing a fluorinated gas, a plasma-polymerized film on a pattern inner wall processed in the etching step, etc., can efficiently be removed. Such a plasma-polymerized film contains an etching residue component in many cases, and even in such a case, the plasma-polymerized film can favorably be removed.

Further, in addition to the plasma-polymerized film, grease attached to a member such as an electronic component of e.g. IC, a precision machinery component or a glass substrate, or a stain such as a flux of e.g. a printed board, can also be removed.

Such grease or a stain can easily be removed as compared with the plasma-polymerized film, and as described in after-mentioned Examples, they can favorably be removed even when the number of carbon atoms of the Rf group in the fluorinated solvent is at most 3. Further, a higher cleaning effect can be obtained, and cleaning can be carried out efficiently, since cleaning is conducted under such an atmospheric pressure that the fluorinated solvent is in a liquid state at a temperature of at least the normal boiling point.

Now, the first embodiment of the present invention will be described in further detail with reference to Examples. However, it should be understood that the first embodiment of the present invention is by no means restricted to such specific Examples.

In the following Examples, evaluation of dissolution and removal of the plasma-polymerized film from the substrate, and the degree of cleanness at the pattern side walls and the bottom part of the substrate, were visually carried out.

### Example 1

On a silicon substrate, a resist pattern having a width of from 50 to 300 mm was formed by known photolithography. This silicon substrate was etched by alternate treatment with SF₆ gas plasma and C₄F₈ gas plasma to form a pattern comprising silicon.

Then, the substrate was placed in a container capable of being closed, and a fluorinated solvent comprising C₆F₁₃CH₂CH₃ (Test Example 7) was introduced into the container so that the substrate was immersed in the fluorinated solvent.

The container was closed, and the temperature in the container and the temperature of the fluorinated solvent were raised to 170° C. and in addition, the container was closed and the pressure in the container was adjusted to 0.5 MPa by a back pressure valve, whereby the fluorinated solvent was converted to a liquid at high temperature of at least the normal boiling point (hereinafter referred to as a high temperature liquid). 30 Minutes later, while the temperature in the closed container was maintained constant, the fluorinated solvent was discharged outside the closed container, and the substrate was taken out from the container. Drying of the substrate was unnecessary.

On the substrate after cleaning, the plasma-polymerized film attached to the pattern side walls was dissolved and removed.

### Example 2

A substrate was immersed in a fluorinated solvent for 30 minutes in the same manner as in Example 1, and then the heater of the closed container was turned off and in addition, the fluorinated solvent was discharged outside the closed container, and the container was taken out from the substrate. The taken out substrate was heated to 100° C. under vacuum of 0.1 Pa, and the fluorinated solvent remaining on the substrate surface was vaporized to dry the substrate.

On the substrate after cleaning, the plasma-polymerized film attached to the pattern side wall was dissolved and removed.

### Example 3

An inner wall cover of an etching apparatus in which C₄F₈ gas plasma or CHF₃ gas plasma had been used was placed in a container capable of being closed, and a fluorinated solvent comprising C₆F₁₃CH₂CH₃ (Test Example 7) was introduced to the container so that the inner wall cover was immersed in the fluorinated solvent.

In such a state, the temperature in the container and the temperature of the fluorinated solvent were raised to 170° C. The pressure in the container was not particularly controlled, but the pressure in the container was at least 0.5 MPa, and the fluorinated solvent was maintained in a high temperature liquid state. 30 Minutes later, the fluorinated solvent was discharged outside the closed container while the temperature in the closed container was maintained constant, and the inner wall cover was taken out from the container. Drying of the inner wall cover was unnecessary.

On the inner wall cover after cleaning, the plasma-polymerized film attached was dissolved and removed.

### Example 4

On a substrate having a copper wiring formed and an insulating film comprising methylsilsesquioxane formed on the copper wiring, a resist pattern having a width of from 30 to 100 nm was formed by known photolithography. Then, the insulating film was etched by CHF₃/CF₄/Ar mixed gas plasma to form an insulating film pattern. Then, the substrate was placed in a container capable of being closed, the temperature of which was adjusted to 170° C., and brought into a closed state. A fluorinated solvent comprising C₆F₁₃CH₂CH₃ (Test Example 7) was introduced into the container so that the substrate was immersed in the fluorinated solvent. In such a state, the temperature in the container and the temperature of the fluorinated solvent were maintained at 170° C. and in addition, the pressure in the container was adjusted to 2.0 MPa by a back pressure valve.

While the fluorinated solvent was made to flow at a rate of 100 cc/min, the plasma-polymerized film attached to the pattern side walls was dissolved and removed. 10 Minutes later, while the temperature in the closed container was maintained constant, the fluorinated solvent was discharged outside the closed container, and the substrate was taken out from the container. Drying of the substrate was unnecessary.

On the substrate after cleaning, the plasma-polymerized film attached to the pattern side walls was dissolved and removed.

### Example 5

A substrate was immersed in a fluorinated solvent in the same manner as in Example 4 except that the fluorinated solvent was changed to C₄F₉OCH₃ (Test Example 3) and that the temperature in the container was 150° C. The substrate was immersed for 10 minutes in such a state, and then the temperature in the container was raised to 200° C. to convert the fluorinated solvent to a supercritical state. After this state was maintained for 10 minutes, while the temperature in the closed container was maintained constant, the fluorinated solvent was discharge outside the closed container, and the substrate was taken out from the container. Drying of the substrate was unnecessary.

On the substrate after cleaning, the plasma-polymerized film attached to the pattern side walls was dissolved and removed.

### Example 6

On a substrate having a copper wiring formed and an insulating film comprising methylsilsesquioxane formed on the copper wiring, a resist pattern having a width of from 30 to 100 nm was formed by known photolithography. Then, the insulating film was etched by CHF₃/CF₄/Ar mixed gas plasma to form an insulating film pattern. Then, the substrate was placed in a container capable of being closed, the temperature of which was adjusted to 170° C., and brought into a closed state. Into the container, a mixed liquid comprising 90 mass % of C₆F₁₃CH₂CH₃ (Test Example 7) and 10 mass % of trifluoroethanol (CF₃CH₂OH) was introduced, and the temperature in the container and the temperature of the mixed liquid were maintained at 170° C. and in addition, the pressure in the container was adjusted to 0.8 MPa by a back pressure valve. While the mixed liquid was made to flow at a rate of 100 ml/min in a state where the substrate was immersed in the mixed liquid, the plasma-polymerized film formed by CHF₃ attached to the pattern side walls was dissolved and removed. Further, an oxide and a fluoride of copper formed at the time of etching, on the pattern bottom part, were also removed. After this state was maintained for 10 minutes, while the temperature was maintained at 170° C., the fluorine compound was discharged outside the closed container, and the substrate was taken out.

On the substrate after cleaning, the pattern side walls and the bottom were in a clean state.

### Example 7

In Example 1, the fluorinated solvent was changed to C₄F₉OCH₂CH₃ (Test Example 4), the temperature in the container was 150° C., and the pressure in the container was elevated up to 1.2 MPa by a pressure pump. Then, the temperature in the container was adjusted to 150° C. and in addition, the pressure was adjusted to 1.2 MPa by a valve. In the same manner as in Example 1 except for the above, the substrate was immersed in the fluorinated solvent in a high temperature liquid state for 30 minutes. Then, while the temperature in the closed container was maintained constant, the fluorinated solvent was discharged outside the closed container, and the substrate was taken out from the container. Drying of the substrate was unnecessary.

On the substrate after cleaning, the plasma-polymerized film attached to the pattern side walls was dissolved and removed.

### Example 8

In Example 1, the fluorinated solvent was changed to an acidic mixed liquid comprising 90 mass % of C₄F₉OCH₃ (Test Example 3) and 10 mass % of trifluoroethanol (CF₃CH₂OH), the temperature in the container was 150° C., and the pressure in the container was adjusted to 1.5 MPa by a back pressure valve. In the same manner as in Example 1 except for the above, the substrate was immersed in the fluorinated solvent in a high temperature liquid state for 30 minutes. Then, while the temperature in the closed container was maintained constant, the fluorinated solvent was discharged outside the closed container, and the substrate was taken out from the container. Drying of the substrate was unnecessary.

On the substrate after cleaning, the plasma-polymerized film attached to the pattern side walls was dissolved and removed.

### Example 9

In Example 1, the fluorinated solvent was changed to an alkaline mixed liquid comprising 90 mass % of C₆F₁₃H (Test Example 9) and 10 mass % of dimethylethanolamine, the temperature in the container was 100° C., and the pressure in the container was adjusted to 0.8 MPa by a back pressure valve. In the same manner as in Example 1 except for the above, the substrate was immersed in the fluorinated solvent in a high temperature liquid state for 30 minutes. Then, while the temperature in the closed container was maintained constant, the fluorinated solvent was discharged outside the closed container, and the substrate was taken out from the container. Drying of the substrate was unnecessary.

On the substrate after cleaning, the plasma-polymerized film attached to the pattern side walls was dissolved and removed. Further, the resist remaining on the pattern upper part could also be dissolved and removed.

### Example 10

A substrate was immersed in a fluorinated solvent (C₆F₁₃CH₂CH₃ (Test Example 7)) in a closed container in the same manner as in Example 1 except that the temperature of the fluorinated solvent (C₆F₁₃CH₂CH₃) was changed to 150° C. 30 Minutes later, while the temperature was maintained constant, C₂F₄HOCH₂CF₃ (Test Example 1) was introduced to the closed container to replace C₆F₁₃CH₂CH₃ with another fluorinated solvent (C₂F₄HOCH₂CF₃). Immediately after replacement, while the temperature was maintained, said another fluorinated solvent was discharged outside the closed container, and the substrate was taken out from the container. Drying of the substrate was unnecessary. On the substrate after cleaning, the plasma-polymerized film attached to the pattern side walls was dissolved and removed.

### Example 11

An insulating film pattern was formed in the same manner as in Example 6, and then the resist pattern was removed by known plasma ashing method. Then, the substrate was placed in a container, the temperature of which was adjusted to 220° C., and brought into a closed state. A mixed liquid (fluorinated solvent) comprising 80 mass % of C₆F₁₃CH₂CH₃ (Test Example 7) and 20 mass % of C₄F₉OCH₂CH₃ (Test Example 4) was introduced to the container, and the temperature in the container and the temperature of the mixed liquid were maintained at 220° C. and in addition, the pressure in the container was adjusted to 1.5 MPa by a back pressure valve. Then, the substrate was maintained for 30 minutes in a state where it was immersed in the mixed liquid. In this step, since C₄F₉OCH₂CH₃ was thermally decomposed to discharge hydrogen fluoride, the insulating film was etched for about 10 nm. As a result, the remaining plasma-polymerized film was removed and in addition, particles of the resist pattern which had not been removed and had remained on the surface of the insulating film were also separated by lift-off. Then, the heater was turned off and in addition, the fluorinated solvent was discharged outside the closed container, and the substrate was taken out from the container. The temperature of the substrate then was 140° C. In such a manner, a silicon substrate having a clean surface was obtained.

### Example 12

In this Example, an inner wall made of stainless steel of a reactive ion etching apparatus employing CHF₃ gas plasma was cleaned.

First, the inner wall made of stainless steel was placed in a container capable of being closed, and the container was filled with a fluorinated solvent comprising C₄F₉OCH₂CH₃ (Test Example 4). The container was closed, and the temperature in the container and the temperature of the fluorinated solvent were raised to 150° C. The pressure in the container became 1.2 MPa by adjusting the amount of the fluorinated solvent, whereby the fluorinated solvent was converted to a high temperature liquid. 30 Minutes later, while the temperature in the closed container was maintained constant, the fluorinated solvent was discharged outside the closed container, and the inner wall made of stainless steel was taken out from the container. Drying of the inner wall made of stainless steel was unnecessary.

On the inner wall made of stainless steel after cleaning, the attached plasma-polymerized film was dissolved and removed.

### Example 13

In this Example, an apparatus component made of a ceramic of an inductively coupled plasma etching apparatus employing C₄F₈ gas plasma was cleaned.

First, the apparatus component made of a ceramic was placed in a container capable of being closed, and the container was filled with a fluorinated solvent comprising C₆F₁₃CH₂CH₃ (Test Example 7).

The container was closed, and the temperature in the container and the temperature of the fluorinated solvent were raised to 170° C. The pressure in the container became 1.5 MPa by adjusting the amount of the fluorinated solvent, whereby the fluorinated solvent was converted to a high temperature liquid. 30 Minutes later, while the temperature in the closed container was maintained constant, the fluorinated solvent was discharged outside the closed container, and the apparatus component made of a ceramic was taken out from the container. Drying of the apparatus component made of a ceramic was unnecessary.

On the apparatus component made of a ceramic after cleaning, the attached plasma-polymerized film was dissolved and removed.

### Example 14

In this Example, an electronic component was soldered on a circuit board, and then to remove the excess soldering flux JS-64ND (tradename, manufactured by KOKI Company, Ltd.), the substrate was placed in a container capable of being closed, and a fluorinated solvent comprising C₂F₄HOCH₂CF₃ (Test Example 1) was introduced to the container, and the substrate was immersed in the fluorinated solvent.

The container was closed, and the temperature in the container and the temperature of the fluorinated solvent was raised to 100° C. and in addition, the pressure in the container was adjusted to 1.0 MPa by a back pressure valve, whereby the fluorinated solvent was converted to a high temperature liquid. 30 Minutes later, while the temperature in the closed container was maintained constant, the fluorinated solvent was discharged outside the closed container, and the substrate was taken out from the container. Drying of the substrate was unnecessary.

The substrate after cleaning was more favorably cleaned as compared with one cleaned by using the same fluorinated solvent while applying ultrasonic waves at room temperature.

### Example 15

In this Example, a circuit board to the surface of which grease was attached, was placed in a container capable of being closed, and a fluorinated solvent comprising C₆F₁₃CH₂CH₃ (Test Example 7) was introduced to the container so that the substrate was immersed in the fluorinated solvent.

The container was closed, and the temperature in the container and the temperature of the fluorinated solvent were raised to 170° C. and in addition, the pressure in the container was adjusted to 0.5 MPa by a back pressure valve, whereby the fluorinated solvent was converted to a high temperature liquid. 30 Minutes later, while the temperature in the closed container was maintained constant, the fluorinated solvent was discharged outside the closed container, and the substrate was taken out from the container. Drying of the substrate was unnecessary.

The substrate after cleaning was more favorably cleaned as compared with one cleaned by using the same fluorinated solvent while applying ultrasonic waves at room temperature.

### B. Examples for the Second Embodiment of the Present Invention

Now, the second embodiment of the present invention will be described in further detail with reference Examples. However, it should be understood that the second embodiment of the present invention is by no means restricted to such specific Examples.

In the following Examples, evaluation of dissolution and removal of the plasma-polymerized film from the substrate and the degree of cleanness at the pattern side walls and the bottom part of the substrate were visually carried out.

<Test Example for Removal of Plasma-Polymerized Film>

In Table 3 are shown cleaning effects when a plasma-polymerized film was cleaned by using fluorinated solvents comprising various fluorinated compounds (Test Examples 1b to 10b). The fluorinated solvent (cleaning liquid) comprises 100 mass % of a fluorinated compound shown in Table 3. As an object to be cleaned, a plasma-polymerized film (solid film not patterned) having a thickness of from 800 to 900 nm, deposited on a silicon substrate using C₄F₈ gas plasma was used.

Details under “Cleaning conditions” in Table 3 are shown below.

### [Cleaning Conditions]

(1) 30° C./ultrasonic waves: A substrate was cleaned for 10 minutes by a method of immersing the substrate in a fluorinated solvent the temperature of which was adjusted to 30° C. under atmospheric pressure and shaking the fluorinated solvent and the substrate by an ultrasonic vibrator, and then dried by heating in an oven at 120° C. for 1 hour.
(2) 100° C.: A fluorinated solvent was introduced to a closed space and heated to 100° C., and a substrate was immersed in the fluorinated solvent in this state for 1 hour and then taken out.

### [Evaluation]

The substrate cleaned under each conditions was visually observed and evaluated based on evaluation standards ×: plasma-polymerized film remaining over the entire surface, Δ: part of plasma-polymerized film removed but not completely removed, and ◯: plasma-polymerized film completely removed.

TABLE 3

| | Fluorine compound used as fluorinated solvent | | | Cleaning conditions | |
|---|---|---|---|---|---|
| | | Number of carbon | Normal boiling | 30° C./ultrasonic | |
| Test Ex. | Fluorine compound | atoms of Rf group | point (° C.) | waves | 100° C. |
| 1b | C₂F₄HOCH₂CF₃ | 1, 1 | 56 | X | X |
| 2b | C₃F₇OC₃F₆OCFHCF₃ | 3 + 3, 1 | 106 | Δ | X |
| 3b | C₄F₉OCH₃ | 4 | 61 | X | X |
| 4b | C₄F₉OCH₂CH₃ | 4 | 76 | X | Δ |
| 5b | C₄F₉CH₂CH₃ | 4 | 68 | Δ | Δ |
| 6b | C₆F₁₃OCH₃ | 6 | 98 | ◯ | ◯ |
| 7b | C₆F₁₃CH₂CH₃ | 6 | 115 | ◯ | ◯ |
| 8b | C₅F₁₁H | 5 | 48 | ◯ | ◯ |
| 9b | C₆F₁₃H | 6 | 71 | ◯ | ◯ |
| 10b | C₈F₁₇H | 8 | 121 | ◯ | ◯ |

As evident from the results shown in Table 3, it was confirmed that the plasma-polymerized film could be completely removed when cleaned with a fluorinated compound having a linear or branched perfluoroalkyl group having a number of carbon atoms of at least 5 (Test Examples 6b to 10b) in both cases where cleaning was carried out under ultrasonic wave conditions and cleaning was carried out under 100° C. heating conditions. The reason is considered that the plasma-polymerized film has a structure comprising (CF₂)ₙ considered to be its main component, and the plasma-polymerized film is likely to swell when the carbon chain of the Rf group (CₙF₂ₙ₊₁) in the fluorinated solvent is longer (n is larger), and as a result, it is likely to be dissolved.

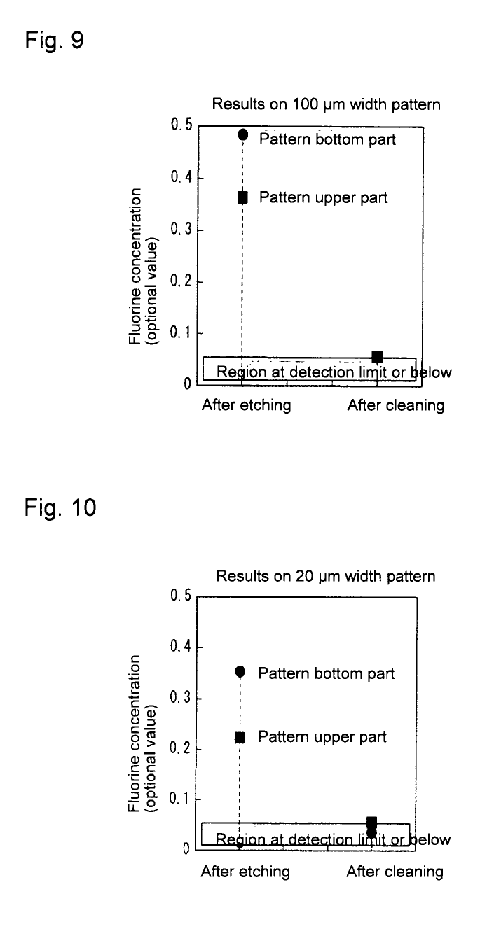

FIGS. 9 and 10 are graphs illustrating the results of Auger spectroscopy examining the degree of cleaning when side surfaces of a silicon pattern (width: 100 μm in FIG. 9, and width: 20 μm in FIG. 10, and depth: 40 μm in both Figs.) etched by alternate treatment with SF₆ gas plasma and C₄F₈ gas plasma, were cleaned with C₆F₁₃CH₂CH₃ (Test Example 7b).

The cleaning was carried out by immersing the pattern in C₆F₁₃CH₂CH₃ (Test Example 7b) heated to 80° C. in a closed state for 30 minutes and then taken out.

As evident from the results shown in FIGS. 9 and 10, the fluorine concentration was decreased to the detection limit or below after cleaning, that is, the plasma-polymerized film is completely removed, independently of the pattern width and the pattern depth.

As described above, according to the cleaning method of the second embodiment of the present invention, an object to be cleaned having a plasma-polymerized film formed in a plasma etching step employing a fluorinated gas can be favorably cleaned to remove the plasma-polymerized film.

Accordingly, a plasma polymer attached to an inner wall cover of an etching apparatus used for a plasma etching step employing a fluorinated gas, a plasma-polymerized film on a pattern inner wall processed in the etching step, etc., can be efficiently removed. Such a plasma-polymerized film contains an etching residue component in addition to the plasma polymer in many cases, and even in such cases, the plasma-polymerized film can be favorably removed.

### Example 1b

On a silicon substrate, a resist pattern having a width of from 50 to 300 nm was formed by means of known photolithography. This silicon substrate was etched by alternate treatment with SF₆ gas plasma and C₄F₈ gas plasma to form a pattern comprising silicon.

Then, the substrate was placed in a container capable of being closed, and a fluorinated solvent comprising C₆F₁₃CH₂CH₃ (Test Example 7b) was introduced into the container, and the substrate was immersed in the fluorinated solvent.

The container was closed, and the temperature in the container and the temperature of the fluorinated solvent were raised to 90° C. 30 Minutes later, while the temperature in the closed container was maintained constant, the fluorinated solvent was discharged outside the closed container, and the substrate was taken out from the container. Drying of the substrate was unnecessary.

On the substrate after cleaning, the plasma-polymerized film attached to the pattern side walls was dissolved and removed.

### Example 2b

A substrate prepared in the same manner as in Example 1b was immersed in a fluorinated solvent comprising C₆F₁₃CH₂CH₃ (Test Example 7b) heated to 50° C. in a cleaning bath, and cleaning by application of ultrasonic waves at from 20 to 100 kHz was carried out for 10 minutes. Then, the fluorinated solvent comprising C₆F₁₃CH₂CH₃ (Test Example 7b) was moved to a vapor rinsing bath heated to the boiling point, and rinsing with C₆F₁₃CH₂CH₃ vapor was carried out for 5 minutes. Then, the substrate was taken out from the vapor rinsing bath and dried in the air as it was.

On the substrate after cleaning, the plasma-polymerized film attached to the pattern side walls was dissolved and removed.

### Example 3b

An inner wall cover of an etching apparatus in which C₄F₈ gas plasma or CHF₃ gas plasma had been used was placed in a container capable of being closed, a fluorinated solvent comprising C₆F₁₃CH₂CH₃ (Test Example 7b) was introduced into the container, and the inner wall cover was immersed in the fluorinated solvent.

In such a state, the temperature in the container and the temperature of the fluorinated solvent were raised to 100° C. 30 Minutes later, while the temperature in the closed container was maintained constant, the fluorinated solvent was discharged outside the closed container, and the inner wall cover was taken out from the container. Drying of the inner wall cover was unnecessary.

On the inner wall cover after cleaning, the attached plasma-polymerized film was dissolved and removed.

### Example 4b

On a substrate having a copper wiring formed and an insulating film comprising methylsilsesquioxane formed on the copper wiring, a resist pattern having a width of from 30 to 100 nm was formed by means of known photolithography. The insulating film was etched by CHF₃/CF₄/Ar mixed gas plasma to form an insulating film pattern. Then, the substrate was placed in a container capable of being closed, the temperature of which was adjusted to 100° C., and brought into a closed state. A fluorinated solvent comprising C₆F₁₃CH₂CH₃ (Test Example 7b) was introduced to the container, and the substrate was immersed in the fluorinated solvent. The fluorinated solvent was made to flow at a rate of 100 cc/min to dissolve and remove the plasma-polymerized film attached to the pattern side walls. 10 Minutes later, while the temperature in the closed container was maintained constant, the fluorinated solvent was discharged outside the closed container, and the substrate was taken out from the container. Drying of the substrate was unnecessary.

On the substrate after cleaning, the plasma-polymerized film attached to the pattern side walls was dissolved and removed.

### Example 5b

In Example 1, the fluorinated solvent was changed to an alkaline mixed liquid comprising 90 mass % of C₆F₁₃H (Test Example 9b) and 10 mass % of dimethylethanolamine, the temperature in the container was 100° C., and the pressure in the container was adjusted to 0.8 MPa by a back pressure valve. In the same manner as in Example 1b except for the above, the substrate was immersed in the fluorinated solvent for 30 minutes. Then, while temperature in the closed container was maintained constant, the fluorinated solvent was discharged outside the closed container, and the substrate was taken out from the container. Drying of the substrate was unnecessary.

On the substrate after cleaning, the plasma-polymerized film attached to the pattern side walls was dissolved and removed.

### Example 6b

In this Example, an apparatus component made of a ceramic, to be set in the interior of an inductively coupled plasma etching apparatus employing C₄F₈ gas plasma, was cleaned.

First, the apparatus component made of a ceramic was placed in a container capable of being closed, and the container was filled with a fluorinated solvent comprising C₆F₁₃CH₂CH₃ (Test Example 7b).

Then, the container was closed, and the temperature in the container and the temperature of the fluorinated solvent were raised to 100° C. 30 Minutes later, while the temperature in the closed container was maintained constant, the fluorinated solvent was discharged outside the closed container, and the apparatus component made of a ceramic was taken out from the container. Drying of the apparatus component made of a ceramic was unnecessary.

On the apparatus component made of a ceramic after cleaning, the attached plasma-polymerized film was dissolved and removed.

### INDUSTRIAL APPLICABILITY

By the cleaning method of the present invention, an object to be cleaned having a plasma polymer formed in a plasma etching step employing a fluorinated gas can be favorably removed, and the cleaning method is suitably employed in a process for producing various substrates such as microelectromechanical systems (MEMS) and large-scale integrated circuits (LSI).

The entire disclosures of Japanese Patent Application No. 2008-133944 filed on May 22, 2008 and Japanese Patent Application No. 2008-133953 filed on May 22, 2008 including specifications, claims, drawings and summaries are incorporated herein by reference in their entireties.

### MEANINGS OF SYMBOLS

1: Substrate
2: Closed container
3: Fluorinated solvent (cleaning liquid)
4: Heater

What is claimed is:

1. A cleaning method comprising an immersion step of immersing an object to be cleaned in a cleaning liquid containing at least a fluorine compound, wherein in the immersion step, the temperature t of the cleaning liquid is at least the lower one of the normal boiling point of the fluorine compound contained in the cleaning liquid at 1 atm and 100° C., and the atmospheric pressure is such a pressure that the fluorine compound is in a liquid state at the temperature t.

2. The cleaning method according to claim 1, wherein the immersion step is carried out in a closed container.

3. The cleaning method according to claim 1, wherein after the immersion step of immersing the object to be cleaned in the cleaning liquid in a liquid state, a step of converting the cleaning liquid to a supercritical fluid is carried out.

4. The cleaning method according to claim 1, wherein the fluorine compound has a linear or branched perfluoroalkyl group having a number of carbon atoms of at least 4.

5. The cleaning method according to claim 1, wherein the object to be cleaned contains at least a plasma polymer formed in a plasma etching step employing a fluorinated gas.

6. A cleaning method comprising an immersion step of immersing an object to be cleaned containing a plasma polymer formed in a plasma etching step employing a fluorinated gas, in a cleaning liquid containing a fluorinated compound, wherein the fluorinated compound has a linear or branched perfluoroalkyl group having a number of carbon atoms of at least 5.

7. The cleaning method according to claim 6, wherein the fluorinated compound is at least one member selected from the group consisting hydrofluoroethers and hydrofluorocarbons.

8. The cleaning method according to claim 7, wherein the fluorinated compound is a hydrofluoroether having a perfluoroalkyl group and an alkyl group bonded by means of an ether bond.

9. The cleaning method according to claim 7, wherein the fluorinated compound is a hydrofluorocarbon represented by Cₙ₊ₘF₂ₙ₊₁H₂ₘ₊₁ (wherein n is an integer of from 5 to 9, and m is an integer of from 0 to 2).
